(19) United States
(12) Patent Application Publication
(10) Pub. No.: US 2008/0097528 A1
(43) Pub. Date: Apr. 24, 2008

(54) Animal pacifying device

(75) Inventor: Cheryl Edwards, Bennington, VT (US)

Correspondence Address: WEISS & WEISS, Suite 251, 300 Old Country Road, Mineola, NY, 11501, US

(73) Assignee: Woodford Productions

(21) Appl. No.: 11/585,420

(22) Filed: Oct. 23, 2006

(51) Int. Cl. A61J 17/00

(52) U.S. Cl. 606/234

(57) ABSTRACT

A device which comprises pacifiers used by animals.

### FIELD OF THE INVENTION

The present invention relates to a device which comprises pacifiers used by animals.

### BACKGROUND OF THE INVENTION

U.S. Pat. No. 6,292,962 and publications 2002/0026670 and 2002/0129447 relate to an infant blanket with teether/pacifier. The blanket or towel has one or more teething elements or pacifiers. The invention is used by draping the blanket/towel across the infant's chest and stomach and initially providing one of the teething or pacifier elements into the infants grasp. Because the blanket/towel generally remains draped across the infant, the pacifier or teething element merely slips down to the infant's chest. By the infant's natural tendency to grip the blanket/towel and thrust the blanket/towel into its mouth, the infant frequently can relocate the pacifier or teething element and reposition it into its mouth.

U.S. Pat. No. 5,665,113 relates to an infant pacifier/pillow which generally has an elongated circular shaped pillow having a central aperture and a side slot, a pacifier with an open center grasping handle and a removable pacifier holder. The pacifier open center grasping handle is slid into the pillows side slot. To hold the open center grasping handle in place, the pacifier holder which is essentially a rod with an end cap, is pushed down through the central aperture and through the handle's open center until the pacifier holder's end cap is substantially flush with the top of the pillow whereby the pacifier is held in place. The pacifier holder is sized approximately to the same diameter as the pillow's central aperture. The pacifier can be easily separated from the pillow.

U.S. Pat. No. 5,534,014 relates to a pillow pacifier. The device includes an elongated body formed of a compressible material which the infant can grasp. A pacifier is removably coupled to a side of the main body such that the main body will extend along a center of the upper torso portion of the infant during use of the pacifier, whereby the infant can embrace and manipulate the device as desired.

U.S. Pat. No. 6,221,093 relates to an infant pacifier and pillow for removably attaching a pacifier to a pillow. The infant pacifier and pillow includes a cushion for removably attaching a pacifier to. The cushion comprises a pillow and covering. The pillow is compressible and the covering encases the pillow. A pacifier for pacifying an infant comprises a nipple and a base. At least one clip for receiving a strap is affixed to and extends away from the base of the pacifier. A bore for receiving a nipple is in the base.

### SUMMARY OF THE INVENTION

The present invention relates to an animal pacifying device comprising: a pillow, wherein the pillow has one or more nipples protruding from it. It is an object of the present invention for the pillow to have stitching and an appliqué of an animal. It is an object of the present invention for the appliqué to be of a cat.

It is an object of the present invention for the appliqué to be made of a fake fur or other fluffy material. It is an object of the present invention for the nipples to protrude through the fur.

It is an object of the present invention for the rear side of the pillow to be made of different fabrics. It is an object of the present invention for the inside of the pillow to be made of stuffing. It is an object of the present invention for the pillow to have side seams. It is an object of the present invention for the nipples to be secured to the pillows by an apparatus located inside of the pillow

### BRIEF DESCRIPTION OF THE DRAWINGS

FIG. 1 shows a front view of the device of the present invention.

FIG. 2 shows a rear view of the device of the present invention.

FIG. 3 shows a cross section of the device of the present invention.

FIG. 4 shows a cross section of the device of the present invention.

### DETAILED DESCRIPTION OF THE INVENTION

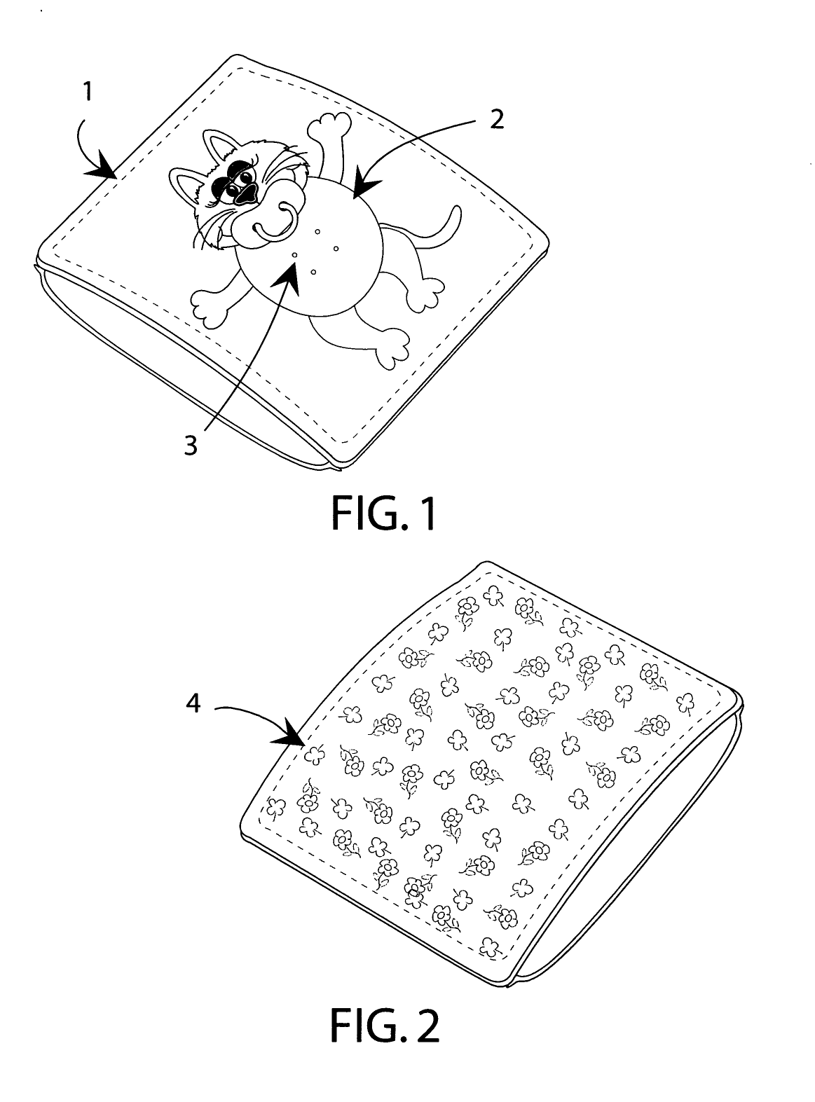

FIG. 1 shows a front view of a nipple pillow 10 which has stitching 1 and an appliqué 2 of an animal. If the pillow is being used for a cat, the appliqué 2 can be of a cat. In a preferred embodiment, the appliqué 2 is made of a fake fur or other fluffy material. Through the fur is located one or more nipples 3.

FIG. 2 shows a rear view of the nipple pillow 10. The rear of the pillow 10 can have different fabrics 4 making up the rear of the pillow 10.

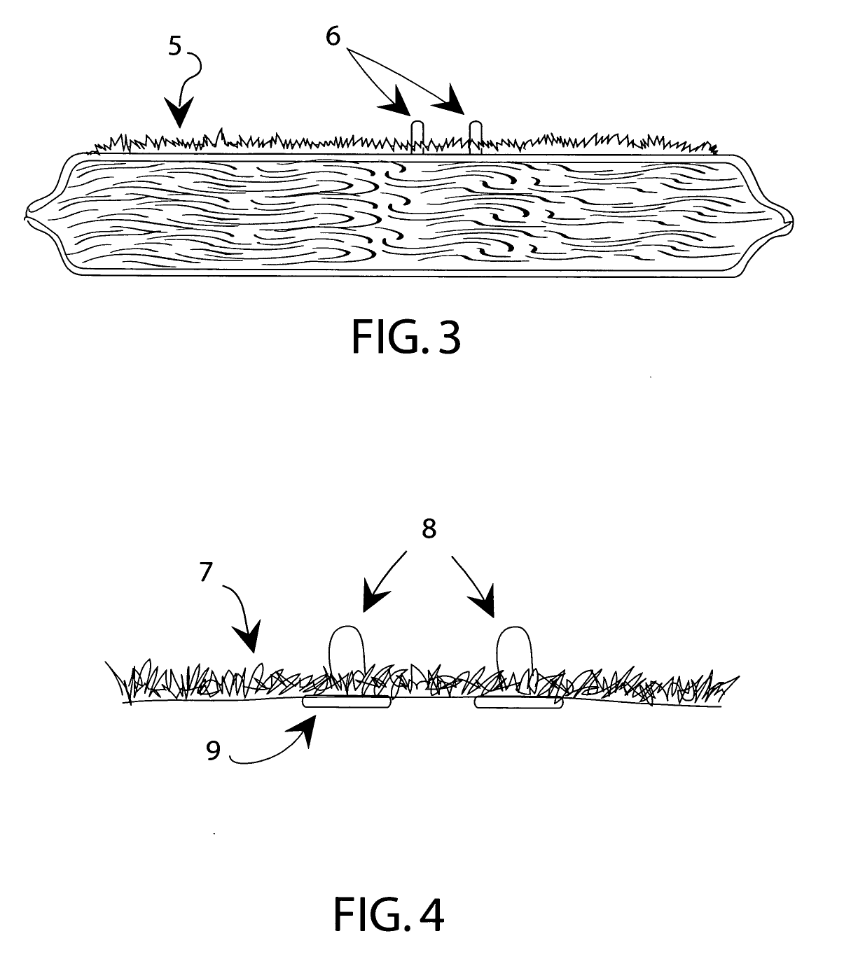

FIG. 3 shows a cross section of the pillow 10. The pillow 10 has the fake fur or other fluffy material 5 which has the nipples 6 piercing through the material. The pillow 10 is filled with a stuffing 11. In a preferred embodiment, the pillow 10 has side seams 12.

FIG. 4 shows a cross section of the pillow 10. The nipples 8 are secured by material 9. The nipples 8 show through the material 7. The material 9 must be strong enough that when the animal is sucking on the nipple 8, that the nipple does not become dislodged from the pillow 10.

1. An animal pacifying device comprising:
a pillow;
said pillows having one or more nipples protruding from it.

2. The device of claim 1 wherein said pillow has stitching and an appliqué of an animal.

3. The device of claim 2 wherein in said appliqué is of a cat.

4. The device of claim 2 wherein said appliqué is made of a fake fur or other fluffy material.

5. The device of claim 4 wherein said nipples protrude through said fur.

6. The device of claim 1 wherein a rear side of said pillow is made of different fabrics.

7. The device of claim 1 wherein inside of said pillow is made of stuffing.

8. The device of claim 1 wherein said pillow has side seams.

9. The device of claim 1 wherein said nipples are secured to said pillow by an apparatus located inside said pillow
